(19) United States
(12) Patent Application Publication
(10) Pub. No.: US 2012/0062629 A1
(43) Pub. Date: Mar. 15, 2012

(54) Piezo-electric inkjet print head and apparatus for driving the print head

(75) Inventors: Young Jae Kim, Gyeonggi-do (KR); Hwa Sun Lee, Gyeonggi-do (KR); Jae Woo Joung, Gyeonggi-do (KR)

(73) Assignee: SAMSUNG ELECTRO-MECHANICS CO., LTD., Suwon (KR)

(21) Appl. No.: 12/929,661

(22) Filed: Feb. 7, 2011

(30) Foreign Application Priority Data
Sep. 10, 2010 (KR) 10-2010-0088950

(51) Int. Cl. B41J 29/38

(52) U.S. Cl. 347/10

(57) ABSTRACT

Disclosed herein are a piezo-electric inkjet print head and an apparatus for driving the print head. The piezo-electric inkjet print head includes: a pressure chamber; a piezo-electric actuator applying a driving force for discharging ink to the pressure chamber; and a pulse applying unit applying a driving pulse to the piezo-electric actuator. The exemplary embodiment of the present invention can obtain the stable discharge characteristics even at the time of discharging at a high frequency of 30 kHz or more by forming the driving waveform of the inkjet head under the condition of measuring the unique vibration period owned by the inkjet head and simultaneously generating constructive interference and destructive interference against the vibrations.

### CROSS REFERENCE TO RELATED APPLICATIONS

This application claims the benefit under 35 U.S.C. Section 119 of Korean Patent Application Serial No. 10-2010-0088950, entitled “Piezo-Electric Inkjet Print Head And Apparatus For Driving The Print Head” filed on Sep. 10, 2010, which is hereby incorporated by reference in its entirety into this application.

### BACKGROUND OF THE INVENTION

1. Technical Field

The present invention relates to a piezo-electric inkjet print head and an apparatus for driving the print head, and more particularly, to a driving technology of a piezo-electric inkjet print head capable of implementing high-speed printing by forming a driving waveform of the inkjet head under the condition of measuring the unique vibration period owned by the inkjet head and simultaneously generating constructive interference and destructive interference.

2. Description of the Related Art

An inkjet print head is an apparatus that discharges minute droplets of printing ink to desired positions on recording paper and prints the recording paper with predetermined colors of images. The inkjet print head may be largely divided into two types based on an ink discharge scheme. One type is a thermal inkjet print head that generates bubbles in ink by using one heat source and discharges ink by using the expansion force of the bubbles and the other type is a piezo-electric inkjet print head that discharges ink using pressure according to deformation of a piezo-electric body.

Recently, the inkjet technology using the piezo-electric scheme is developing day by day and a method of applying the inkjet to various processes such as a color filter, a solar cell, an OLED, a PCB, or the like, has been widely researched.

However, according to the existing inkjet technology, resonance is formed in a chamber according to a motion of an actuator, such that it is difficult to discharge droplets at high speed. Therefore, in order to increase productivity in the process of using the inkjet, research into a technology for controlling an inkjet head driving waveform by using the resonance characteristics of the inkjet head is needed.

### SUMMARY OF THE INVENTION

An object of the present invention is to provide a piezo-electric inkjet print head capable of obtaining stable discharge characteristics even at the time of discharging ink at a high frequency by forming the driving waveform of the inkjet head under the condition of measuring the unique vibration period owned by the inkjet head and simultaneously generating constructive interference and destructive interference against the vibrations, and an apparatus for driving the print head.

According to an exemplary embodiment of the present invention, there is provided a piezo-electric inkjet print head, including: a pressure chamber; a piezo-electric actuator applying a driving force for discharging ink to the pressure chamber; and a pulse applying unit applying a driving pulse to the piezo-electric actuator.

The driving pulse may include: a first falling period in which voltage falls; a first duration period in which the voltage falling in the first falling period is constantly maintained; a rising period in which the voltage maintained in the first duration period rises to voltage having a positive (+) magnitude; a second duration period in which the voltage rising in the rising period is constantly maintained; and a second falling period in which the voltage maintained in the second duration period falls to an original point.

The entire length of the driving pulse may be configured to be the same as the resonance period of the pressure chamber.

The length of the first duration period may be a half of the resonance period of the pressure chamber.

According to an exemplary embodiment of the present invention, there is provided an apparatus for driving an inkjet print head generating a driving pulse and supplying the generated driving pulse to the inkjet print head, the driving pulse including: a first falling period in which voltage falls; a first duration period in which the voltage falling in the first falling period is constantly maintained; a rising period in which the voltage maintained in the first duration period rises to voltage having a positive (+) magnitude; a second duration period in which the voltage rising in the rising period is constantly maintained; and a second falling period in which the voltage maintained in the second duration period falls to an original point.

The entire length of the driving pulse may be configured to be the same as the resonance period of the pressure chamber.

The length of the first duration period may be a half of the resonance period of the pressure chamber.

### BRIEF DESCRIPTION OF THE DRAWINGS

FIG. 1 is a block diagram schematically showing a configuration of a piezo-electric inkjet print head 100 according to an exemplary embodiment of the present invention;

FIG. 2 is a diagram for explaining a piezo-electric actuator driving pulse in a general inkjet head;

FIG. 3 is a diagram for explaining a piezo-electric actuator driving pulse according to an exemplary embodiment of the present invention;

FIGS. 4 and 5 are diagrams for explaining the discharge characteristics of the inkjet head depending on the magnitude change in voltage in period B, according to an exemplary embodiment of the present invention;

FIGS. 6 and 7 are diagrams for explaining the discharge characteristics of the inkjet head depending on the length change of period B, according to an exemplary embodiment of the present invention; and

FIGS. 8A-8B, 9A-9B, 10A-10B, and 11A-11B are diagrams for comparing the pulse waveform according to the related art with the discharge characteristics of the pulse waveform according to the present invention.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

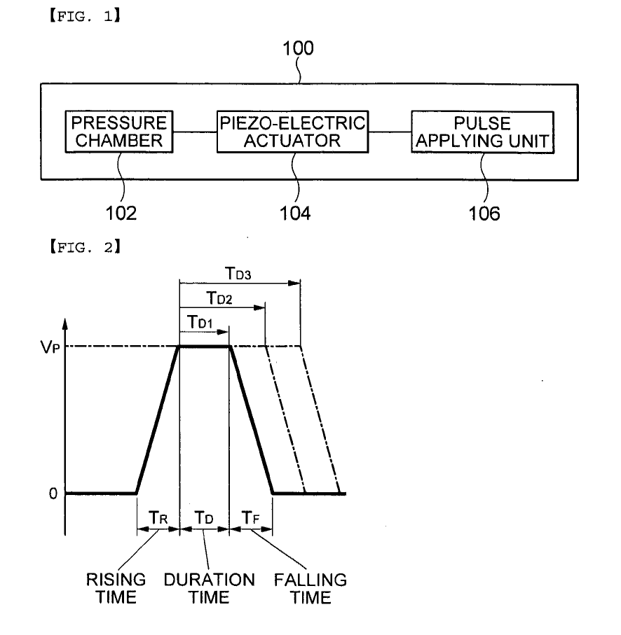

FIG. 1 is a block diagram schematically showing a configuration of a piezo-electric inkjet print head 100 according to an exemplary embodiment of the present invention.

As shown in FIG. 1, the inkjet print head 100 according to an exemplary embodiment of the present invention includes a pressure chamber 102, a piezo-electric actuator 104, and a pulse applying unit 106.

The pressure chamber 102 has ink stored therein and discharges the ink to a nozzle by pressure transferred from a piezo-electric actuator 104. The piezo-electric actuator 104 serves to transfer a driving force for discharging ink to the pressure chamber 102. The piezo-electric actuator 104 is operated by a driving pulse applied from the pulse applying unit 106. That is, when the driving pulse is applied from the pulse applying unit 106, the piezo-electric actuator 104 is contracted according to the driving pulse and transfers the pressure to the pressure chamber 102.

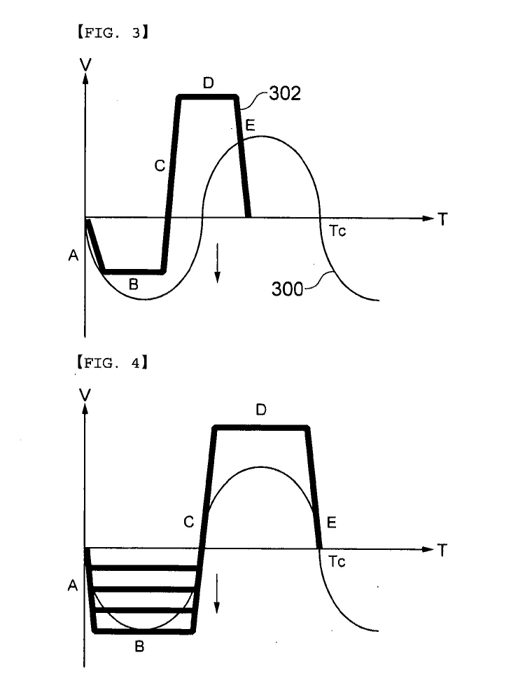

FIG. 2 is a diagram for explaining a piezo-electric actuator driving pulse in a general inkjet head.

As shown in FIG. 2, the driving pulse applied to the piezo-electric actuator for discharging ink droplets may have a trapezoidal waveform. The entire time of the driving pulse having the trapezoidal waveform includes a rising time T_{R} in which voltage is raised, a duration time T_{D} in which a driving voltage is constantly maintained, and a falling time T_{F} in which voltage is lowered. Among others, the volume of droplet discharged through the nozzle can be controlled by controlling the length of the duration time T_{D} in which the driving voltage is constantly maintained. In addition, when the rising time T_{R} in which the voltage is raised is constantly maintained, the discharge rate of the droplet can be constantly maintained. However, it is difficult to show the constructive interference effect with the resonance of the chamber since this type of driving waveform starts at the period of the rising time, which affects the discharge of droplets, regardless of the resonance period of the pressure chamber.

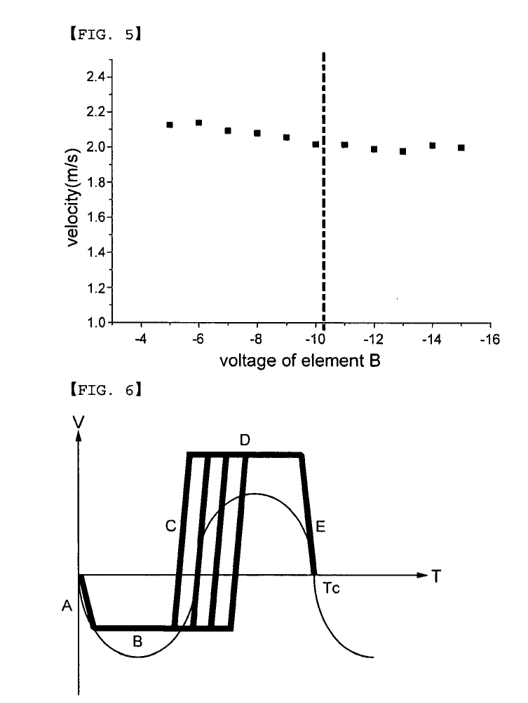

FIG. 3 is a diagram for explaining a piezo-electric actuator driving pulse according to an exemplary embodiment of the present invention.

Generally, when the piezo-electric actuator 104 in the inkjet print head 100 starts vibrating, a predetermined frequency of resonance is generated in the pressure chamber 102. The exemplary embodiment of the present invention synchronizes the driving pulse with the resonance period Tc of the pressure chamber 102, thereby making it possible to attenuate the vibration of the pressure chamber 102 while showing the constructive interference effect with the driving pulse and the resonance.

In FIG. 3, the graph 300 displayed by the sine wave represents the resonance of the pressure chamber 102 and the graph corresponding to reference numeral 302 represents the driving pulse of the piezo-electric actuator. Tc is the resonance frequency of the pressure chamber 102.

As shown in FIG. 3, the driving pulse of the piezo-electric actuator according to the exemplary embodiment of the present invention is a pull and push type. The driving pulse includes a first falling period (period A) in which voltage falls, a first duration period (period B) constantly maintaining the voltage falling in the first falling period, a rising period (period C) in which the voltage maintained in the first duration period rises to a voltage having a positive (+) magnitude, a second duration period (period D) in which the voltage rising in the rising period is constantly maintained, and a second falling period (period E) in which the voltage maintained in the second duration period falls to an original point.

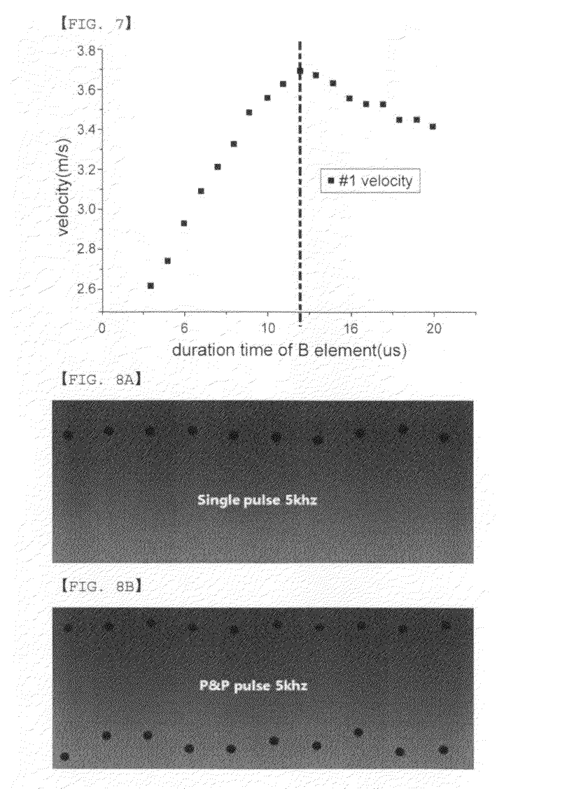

First, as shown in FIG. 4, the discharge characteristics of the inkjet head according to the magnitude change in voltage in period B are the same as the graph in FIG. 5. When the voltage in period B is changed into −4V, −6V, −8V, etc., it can be appreciated from FIG. 5 that the discharge rate of droplets according to the increased magnitude in voltage in period B is reduced and then, maintains the predetermined rate after −10V.

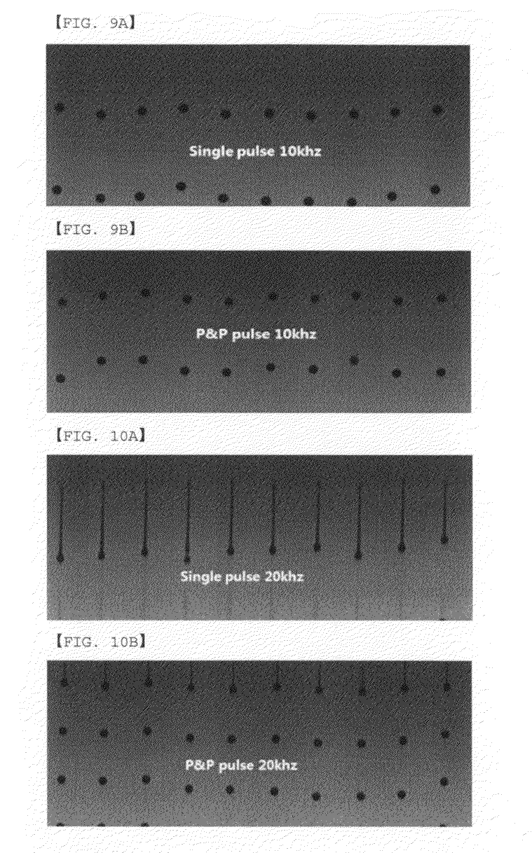

Next, as shown in FIG. 6, the discharge characteristics of the inkjet head according to the change in length in period B are the same as the graph of FIG. 7. As shown in FIG. 6, when the change in length is changed in period B, the position of period C is changed. Since period C is a period which has a direct effect on the discharge of the inkjet head, the length change in period B largely changes the discharge characteristics of the inkjet head. That is, as shown in FIG. 7, when period B is excessively short, the resonance characteristics of the pressure chamber 102 do not match the driving pulse, thereby decreasing the discharge rate of droplets. However, when the length in period B is increasingly increased, the driving pulse is constructively interfered with the resonance period of the pressure chamber 102, such that the discharge rate is increased and is again reduced passing through a peak when a predetermined time passes (12 μs in FIG. 7).

Considering the graph shown in FIGS. 6 and 7, a period in which the discharge rate of the inkjet head is fastest is a period in which the constructive interference between the driving pulse and the resonance period of the pressure chamber 102 becomes the largest. It can be appreciated that period C of FIG. 6 is a period corresponding to half of the resonance period of the pressure chamber 102. That is, the high frequency discharge characteristics can be improved so that the length of the first duration period (period B) corresponds to half of the resonance period of the pressure chamber while the entire length of the driving pulse is the same as the resonance period of the pressure chamber 102.

In the exemplary embodiment of FIG. 7, when the length of the period B is 12 μs, the best discharge characteristics are shown. As a result, it can be appreciated that the resonance period of the pressure chamber 102 is 24 μs. Therefore, when period E is positioned at a position for reducing (damping) the resonance generated in the pressure chamber 102, the high frequency discharge characteristics can be improved.

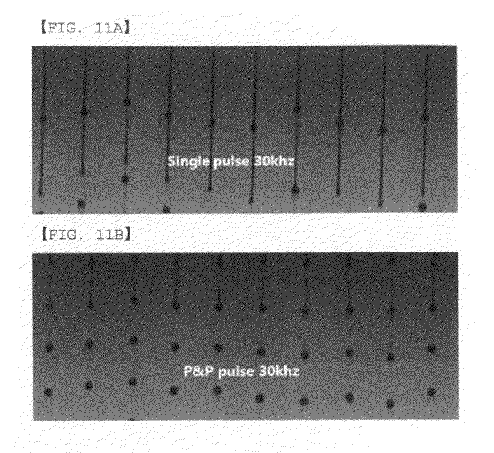

FIGS. 8 to 11 are diagrams comparing the discharge characteristics between the generally used single pulse waveform and the Pull & Push waveform in the present invention in order to verify the phenomenon. FIGS. 8A and 8B show the discharge characteristics at 5 KHz, FIGS. 9A and 9B show the discharge characteristics at 10 KHz, FIGS. 10Aa and 10B show the discharge characteristics at 20 KHz, and FIGS. 11A and 11B show the discharge characteristics at 30 KHz.

As shown, in the case of the general driving waveform (FIGS. 8A, 9A, 10A, and 11A), the discharge characteristics are sharply degraded according to the increased discharge frequency, but it can be appreciated that the exemplary embodiments of the present invention (FIGS. 8B, 9B, 10B, and 11B) has stable discharge characteristics at 30 KHz or more.

As set forth above, the exemplary embodiments of the present invention can obtain stable discharge characteristics even at the time of discharging at a high frequency of 30 kHz or more by forming the driving waveform of the inkjet head under the condition of measuring the unique vibration period owned by the inkjet head and simultaneously generating constructive interference and destructive interference against the vibrations.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. A piezo-electric inkjet print head, comprising:
a pressure chamber;
a piezo-electric actuator applying a driving force for discharging ink to the pressure chamber; and
a pulse applying unit applying a driving pulse to the piezo-electric actuator.

2. The piezo-electric inkjet print head according to claim 1, wherein the driving pulse includes:
a first falling period in which voltage falls;
a first duration period in which the voltage falling in the first falling period is constantly maintained;
a rising period in which the voltage maintained in the first duration period rises to voltage having a positive (+) magnitude;
a second duration period in which the voltage rising in the rising period is constantly maintained; and
a second falling period in which the voltage maintained in the second duration period falls to an original point.

3. The piezo-electric inkjet print head according to claim 2, wherein the entire length of the driving pulse is configured to be the same as the resonance period of the pressure chamber.

4. The piezo-electric inkjet print head according to claim 3, wherein the length of the first duration period is half of the resonance period of the pressure chamber.

5. An apparatus for driving an inkjet print head generating a driving pulse and supplying the generated driving pulse to the inkjet print head, the driving pulse including:
a first falling period in which voltage falls;
a first duration period in which the voltage falling in the first falling period is constantly maintained;
a rising period in which the voltage maintained in the first duration period rises to voltage having a positive (+) magnitude;
a second duration period in which the voltage rising in the rising period is constantly maintained; and
a second falling period in which the voltage maintained in the second duration period falls to an original point.

6. The apparatus for driving an inkjet print head according to claim 5, wherein the entire length of the driving pulse is configured to be the same as the resonance period of the pressure chamber.

7. The apparatus for driving an inkjet print head according to claim 6, wherein the length of the first duration period is half of the resonance period of the pressure chamber.
